(19) United States
(12) Patent Application Publication
(10) Pub. No.: US 2026/0180778 A1
(43) Pub. Date: Jun. 25, 2026

(54) SELF-ADAPTATION METHOD FOR OPTIMIZING MULTIPLE COMMUNICATION MODULES COEXISTING IN FREQUENCY-DIVISION DUPLEXING AND COMMUNICATION SYSTEM THEREOF

(71) Applicant: REALTEK SEMICONDUCTOR CORP., HSINCHU (TW)

(72) Inventors: CHIEH-LIN HO, HSINCHU (TW); Chih-Hung Tsai, Kaohsiung City (TW); SSU-YI TSAI, HSINCHU (TW)

(21) Appl. No.: 19/270,602

(22) Filed: Jul. 16, 2025

(30) Foreign Application Priority Data
Dec. 24, 2024 (TW) 113150310

(51) Int. Cl. H04L 5/14

(52) U.S. Cl. CPC H04L 5/1438; H04L 5/1469

(57) ABSTRACT

A self-adaptation method for optimizing multiple communication modules coexisting in frequency-division duplexing is provided. The method is operated in a communication system having at least two communication modules. Communication data generated by the communication modules is obtained when the communication system is operated under a time-division duplexing mode. The communication data is used to establish a standard comparison value for a frequency-division duplexing mode. The communication system then enters a parameter-adjustment phase, and radio-frequency parameters for the communication modules can be obtained. Thus, based on the standard comparison value, key performance indicator check is periodically performed for assessing whether to start or to stop a frequency-divisional duplexing training process according to one or more reference indicators so as to determine whether the radio-frequency parameters need to be adjusted. A set of radio-frequency parameters suitably operating the communication system under the frequency-division duplexing mode are finally obtained.

### CROSS-REFERENCE TO RELATED PATENT APPLICATION

This application claims the benefit of priority to Taiwan Patent Application No. 113150310, filed on Dec. 24, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of coexisting modules that process different communication protocols, and more particularly to a self-adaptation method and a communication system that relies on feedback parameters and monitored real-time coexisting performance to automatically adjust radio-frequency parameters of the communication system for optimizing multiple communication modules coexisting in frequency-division duplexing.

### BACKGROUND OF THE DISCLOSURE

Typically, a communication system installed in electronic devices such as mobile devices and wireless network devices includes both a wireless network (WiFi™) module and a Bluetooth™ communication module. The wireless network module and the Bluetooth™ communication module can be implemented by a system on a chip (SoC), but can work independently due to individual radio-frequency transceiver circuits and antennas being disposed therein.

The communication system has the system on a chip including both the wireless network module and the Bluetooth™ communication module. In a practical application, the system on a chip may operate under a frequency-division duplexing mode since the wireless network module and the Bluetooth™ communication module need to transmit and receive signals at the same time. When the communication system is in operation under the frequency-division duplexing mode, the communication modules may still operate in the same frequency band even if they work under a frequency division approach. Therefore, the signals under different communication protocols in the communication system may interfere with each other.

A signal timing diagram of a conventional system on a chip combining the wireless network module and the Bluetooth™ communication module can be referred to in FIG. 1, which shows a Bluetooth™ communication timing sequence and a wireless network timing sequence.

The Bluetooth™ communication timing sequence is formed based on operations of the Bluetooth™ communication module. The Bluetooth™ communication timing sequence includes transmission (TX) frames 111, 113, 115, 117, 119 and reception (RX) frames 112, 114, 116, 118, 120 that are sequentially switched between transmission and reception. In the same period of time, the wireless network module is also in operation and the wireless network timing sequence includes a downlink phase and an uplink phase.

According to the wireless network timing sequence, the wireless network module firstly receives a request to send (RTS) control frame 131 and then transmits a clear to send (CTS) control frame 132 in the downlink phase. After that, the wireless network module receives an aggregated data 133 from a signal source. After the data is completely received, the wireless network module sends a Block ACK (BA) frame 134. Subsequently, the wireless network module again receives an aggregated data 135 and transmits a Block ACK frame 136. The wireless network module repeatedly receives data and transmits Block ACK frames until the data is completely received.

In the uplink phase, the wireless network module firstly sends an RTS control frame 137 to a receiver, and then receives a CTS control frame 138. An aggregated data 139 is then transmitted and a Block ACK frame 140 is received. After that, aggregated data 141 is transmitted and a Block ACK frame 142 is received. The data and the Block ACK frame are repeatedly transmitted and received until the data is completely transmitted.

The Bluetooth™ communication module and the wireless network module transmit or receive signals at the same time based on the Bluetooth™ communication timing sequence and the wireless network timing sequence, such as to cause interferences among the signals. For example, the transmit (TX) frames 113 transmitted by the Bluetooth™ communication module and the aggregated data 133 received by the wireless network module in a downlink phase are interfered with each other; or, the transmit (TX) frames 117 transmitted by the Bluetooth™ communication module and the aggregated data 139 transmitted by the wireless network module in an uplink phase are also interfered with each other.

The degree of interference of the signals under the two communication protocols depend on a degree of isolation between two antennas, and transmit powers and receive gains of radio-frequency links of the two communication modules. Therefore, the radio-frequency parameters should be properly regulated for different hardware architectures so as to optimize a signal-to-noise ratio (SNR) and reduce risks of signal interference. However, the regulated radio-frequency parameters cannot be adapted to all of the hardware architecture, and therefore the conventional technologies are required to provide corresponding solutions to the various manufacturers of different hardware architectures. Nevertheless, the conventional technologies still encounter problems such as poor efficiency since it takes a long time to manually adjust the radio-frequency parameters for some specific products; poor applicability since the radio-frequency parameters adapted to certain products from some manufacturers may not be applicable to products of other manufacturers; poor adaptability since the regulated radio-frequency parameters may not be adapted to requirements of all of coexisting check scenarios of the manufacturers; and an increase in development costs and loads on system integrators.

### SUMMARY OF THE DISCLOSURE

For a need that radio-frequency parameters are required to be adjusted for solving the interferences caused by different wireless communication modules disposed by various manufacturers into one communication system, provided in the present disclosure is a self-adaptation method for optimizing multiple communication modules coexisting in frequency-division duplexing and a communication system. The communication system operates a frequency-division duplexing training process, by which the parameters feedback by the communication system and radio-frequency parameters that are automatically adjusted by monitoring coexisting performance in real time are referred to for optimizing data throughput of the wireless network module, and also ensuring a stable transmission for a Bluetooth™ communication module.

The communication system includes at least two communication modules that operate under different communication protocols. A processor of the communication system performs the self-adaptation method for optimizing multiple communication modules coexisting in frequency-division duplexing. The communication system operates under a time-division duplexing mode in advance, and receives communication data generated by a first communication module and a second communication module of the at least two communication modules so as to establish standard comparison values for the communication system which operates under a frequency-division duplexing mode. Next, the communication system enters a parameter-adjustment phase for receiving radio-frequency parameters for the at least two communication modules. Afterwards, according to the standard comparison values, a key performance indicator check (KPI check) is periodically performed. In the KPI check, one or more reference indicators are referred to for assessing whether or not to start or to stop a frequency-division duplexing training process so as to determine whether or not the radio-frequency parameters of the at least two communication modules are required to be adjusted. A set of radio-frequency parameters for the communication system under the frequency-division duplexing mode can be obtained.

Further, in the process of KPI check, the communication system firstly determines whether the at least two communication modules operating under different communication protocols operate with individual antennas to determine whether or not to perform the frequency-division duplexing training process. When the at least two communication modules operating under different communication protocols do not operate with individual antennas, the frequency-division duplexing training process is stopped.

On the contrary, when it is confirmed that the at least two communication modules operate with individual antennas, the process goes on to determine whether the second communication module connects with an access point that is operated in a frequency band. The frequency-division duplexing training process is stopped when the second communication module does not connect with the access point that operates in the frequency band.

Further, in the key performance indicator check, antenna isolation between the at least two communication modules is measured. Whether or not the frequency-division duplexing training process is performed based on whether the antenna isolation meets an isolation threshold set by the communication system is determined. When the antenna isolation of the at least two communication modules meets an isolation threshold, the method goes on to determine whether the at least two communication modules are in a non-idle state. The frequency-division duplexing training process is stopped when any or all of the at least two communication module is under an idle state.

Further, in the key performance indicator, whether the frequency-division duplexing training process is performed is determined according to whether a stereo audio transmission profile that regulates a first communication module of the at least two communication modules to transmit or receive audio is stored in a memory of the communication system. When the memory does not store the stereo audio transmission profile, the frequency-division duplexing training process is stopped. When the memory stores the stereo audio transmission profile, the frequency-division duplexing training process is performed.

According to certain embodiments of the present disclosure, the at least two communication modules include a first communication module that can be the Bluetooth™ communication module and a second communication module that can be a wireless network module. The communication data that can be used as standard comparison values includes signal strengths of signals of the Bluetooth™ communication module and the wireless network module when the communication system operates under the time-division duplexing mode, and network throughput of the wireless network module.

The radio-frequency parameters of the at least two communication modules include a transmission power level of the wireless network module, a transmission power level of the Bluetooth™ communication module and a Bluetooth™ RX low-noise amplifier gain.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a signal timing diagram for a conventional system on a chip of a combination of a wireless network module and a Bluetooth™ communication module;

FIG. 2 is a schematic diagram depicting a communication system operating a frequency-division duplexing training process according to one embodiment of the present disclosure;

FIG. 3 is a schematic diagram depicting a framework of the communication system having multiple communication modules according to one embodiment of the present disclosure;

FIG. 4 is a flowchart illustrating a key performance indicator check process in a self-adaptation method for optimizing multiple communication modules coexisting in frequency-division duplexing according to one embodiment of the present disclosure;

FIG. 5 is a flowchart illustrating a self-adaptation process in the self-adaptation method for optimizing multiple communication modules coexisting in frequency-division duplexing according to one embodiment of the present disclosure;

FIG. 6 is an exemplary example of a signal strength relationship table for wireless network and Bluetooth™ communication modules;

FIG. 7 is a schematic diagram showing consideration factors of key performance indicator check in one embodiment of the present disclosure;

FIG. 8 is a flowchart illustrating a process of applying the self-adaptation method for optimizing multiple communication modules coexisting in frequency-division duplexing according to one embodiment of the present disclosure; and

FIG. 9 is another flowchart illustrating another process of applying the self-adaptation method for optimizing multiple communication modules coexisting in frequency-division duplexing in another embodiment of the present disclosure.

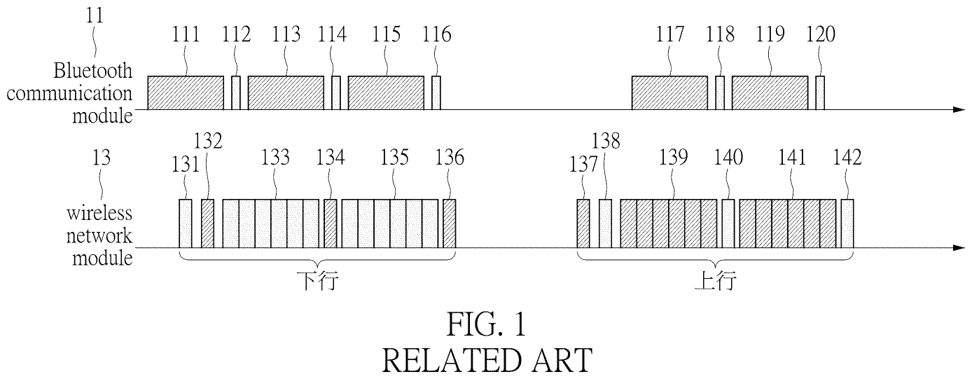

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a self-adaptation method for optimizing multiple communication modules coexisting in frequency-division duplexing (FDD) and the method can be operated in a communication system. The communication system having multiple independent antennas can be operated with different communication protocols in a same frequency band. For example, the communication system includes a wireless network (WiFi™) module and a Bluetooth™ communication module, or uses a system on a chip to implement a wireless network circuitry and a Bluetooth™ communication circuitry that can transmit and receive radio-frequency signals via their own antennas.

In one aspect, the communication system operating the self-adaptation method for optimizing multiple communication modules coexisting in frequency-division duplexing performs a frequency-division duplexing training process that can automatically regulate radio-frequency parameters according to parameters fed back by the communication system and a real-time monitored coexisting performance. One of the objectives of the self-adaptation method is to optimize throughput of the wireless network module and also ensure that the Bluetooth™ communication module has a stable transmission performance. Further, for making the training process having a stronger and more durable performance in the self-adaptation method, a mechanism of key performance indicator check (KPI check) is introduced for checking reference indicators fed back by the communication system at any time. The communication system can respond to the reference indicators with appropriate actions such as determining whether to perform the frequency-division duplexing training process for guaranteeing a stable performance of the communication system.

One of the objectives of the frequency-division duplexing training process is to save time for the manufacturer to regulate the radio-frequency parameters of multiple communication modules of the communication system. The aspect of the frequency-division duplexing training process essentially relies on one or more reference indicators to determine whether to re-train for regulating a set of optimized radio-frequency parameters adapted to a product. In other words, even if multiple manufacturers cannot share the same radio-frequency parameters, they still can quickly find a best solution through the frequency-division duplexing training process; or, when one of the manufacturers has multiple coexisting check scenarios, the frequency-division duplexing training process operated in the self-adaptation method for optimizing multiple communication modules coexisting in frequency-division duplexing of the present disclosure can still find the best solution according to a current reference indicator fed back by the communication system.

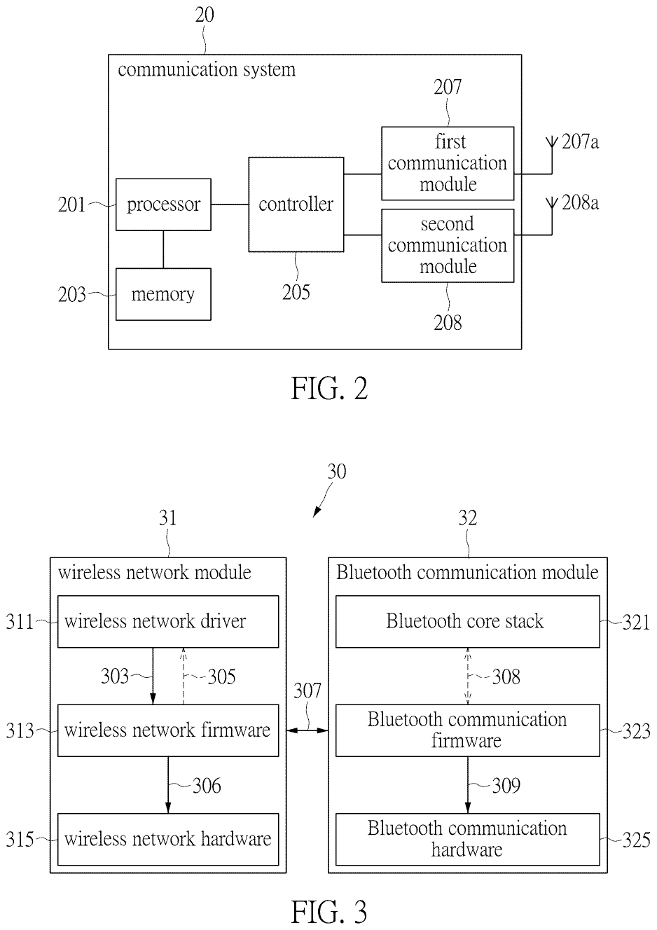

Reference is made to FIG. 2, which is a schematic diagram depicting the communication system that operates the self-adaptation method for optimizing multiple communication modules coexisting in frequency-division duplexing according to one embodiment of the present disclosure. A communication system 20 depicted in the diagram implements a communication device that is formed by one or more circuit modules or a system on a chip (SoC). It should be noted that the SoC is an integrated chip integrating multiple circuit components.

According to the schematic diagram of a system framework shown in FIG. 2, main components of the communication system 20 include a processor 201 used to process data packets and signals generated by other circuit components, a memory 203 that is electrically connected with the processor 201 and that is used to store software programs and operating parameters of the communication system 20, and a controller 205 that is electrically connected with the processor 201. The controller 205 controls operations of the coexisting communication modules of the communication system 20 according to control instructions generated by the processor 201.

The communication system 20 includes a first communication module 207 and a second communication module 208. In one of the embodiments of the present disclosure, the first communication module 207 and the second communication module 208 can respectively be a Bluetooth™ communication module and a wireless network module that operate with circuits and firmware components in different communication protocols. The circuits are such as baseband circuits, modulation circuits and radio frequency circuits used to transmit and receive wireless signals. The different communication modules can be equipped with their individual antennas such as a first antenna 207a and a second antenna 208a shown in the diagram.

The self-adaptation method for optimizing the multiple communication modules that are coexisted in frequency-division duplexing can be performed in the communication system by software or firmware. Reference is made to FIG. 3, which is a schematic diagram depicting a communication system having the wireless network module and the Bluetooth™ communication module as an example. The at least two communication modules of the communication system can be disposed inside a network device, or respectively disposed into different devices and can be communicated with each other. The method of the present disclosure proposes a solution to a problem of interferences caused by the different communication modules that operate in a same frequency band.

Besides the circuit components such as a processor and a controller shown in FIG. 2, a communication system 30 shown in FIG. 3 also includes a wireless network module 31 and a Bluetooth™ communication module 32. The main components of the wireless network module 31 include a wireless network driver (WiFi™ driver) 311, a wireless network firmware 313 and a wireless network hardware 315. The main components of the Bluetooth™ communication module 32 include a Bluetooth™ core stack 321, Bluetooth™ communication firmware 323 and Bluetooth™ communication hardware 325.

When the communication system is in operation, the wireless network module 31 and the Bluetooth™ communication module 32 can be communicated via a physical connection (307), and the communication system performs the self-adaptation method through signals communicated by the circuit components. The wireless network driver 311 is used to drive the wireless network module 31 to operate under a wireless network protocol. The Bluetooth™ communication module 32 operates under a Bluetooth™ communication protocol through the Bluetooth™ core stack 321 so as to establish connections with the peripheral devices for exchanging data and achieving various applications.

According to certain embodiments of the present disclosure, the wireless network driver 311 of the wireless network module 31 and the Bluetooth™ core stack 321 of the Bluetooth™ communication module 32 share information via the physical connections. A frequency-division duplexing training process is operated in each of the communication modules. The wireless network driver 311 assesses whether the frequency-division duplexing training process is started in the self-adaptation method for optimizing multiple communication modules coexisting in frequency-division duplexing. The wireless network driver 311 transmits information of a parameter-adjustment range (303) to the wireless network firmware 313, and then transmits control signals (306) used to operate the frequency-division duplexing training process to the wireless network hardware 315 for performing actual parameter control (e.g., transmission power). After that, the wireless network firmware 313 transmits an adjustment result (305) back to the wireless network driver 311 so as to be exchanged to the Bluetooth™ core stack 321 of the Bluetooth™ communication module 32.

In the Bluetooth™ communication module 32, the Bluetooth™ communication firmware 323 the receive operating information of the wireless network module 31 and the operating information of the Bluetooth™ communication module 32 (308) from the Bluetooth™ core stack 321. Therefore, the Bluetooth™ communication hardware 325 can operate based on the various adjustment parameters (e.g., transmit and receive RF operating parameters (309)) provided by the Bluetooth™ communication firmware 323.

The self-adaptation method for optimizing multiple communication modules coexisting in frequency-division duplexing is essentially adapted to the communication system that operate under the at least two communication protocols, the same frequency band, and the at least two communication modules having their own independent antennas. According to certain embodiments of the present disclosure, the communication system performs the frequency-division duplexing training process through the two different communication modules, e.g., the wireless network firmware 313 and the Bluetooth™ communication firmware 323 shown in FIG. 3.

Based on the above-described system framework, taking the communication system having coexisting wireless network module and Bluetooth™ communication module as an example, mutual interference occurs since the wireless network module and the Bluetooth™ communication module operates in the same frequency band under a frequency-division duplexing mode. The processor of the communication system performs the self-adaptation method for optimizing multiple communication modules coexisting in frequency-division duplexing with reference to various reference indicators so as to determine whether or not the frequency-division duplexing training process is performed.

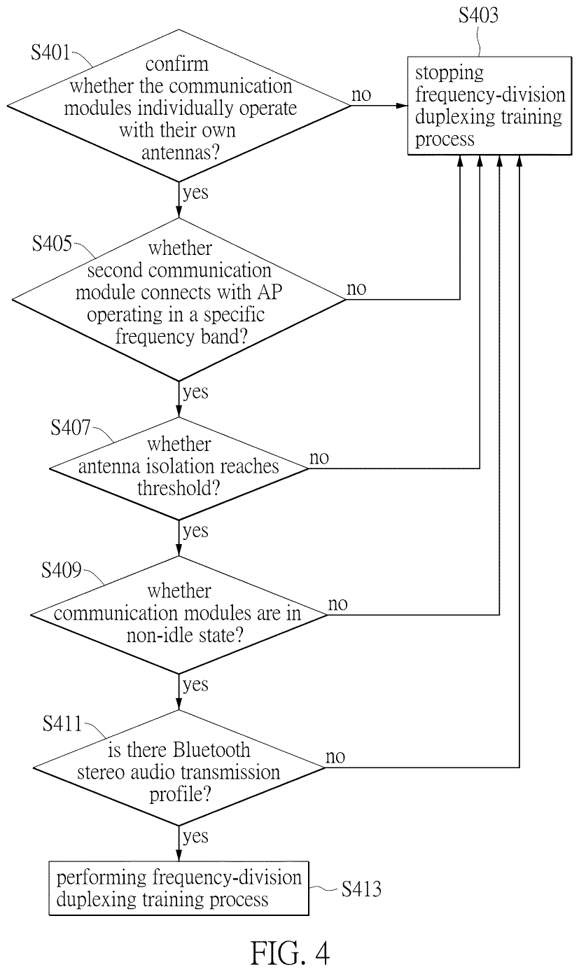

Reference is made to FIG. 4, which is a flowchart illustrating the self-adaptation method for optimizing multiple communication modules coexisting in frequency-division duplexing according to one embodiment of the present disclosure.

In the frequency-division duplexing training process, after the communication system is initialized, one or more reference indicators are checked for determining whether or not the frequency-division duplexing training process is performed through a key performance indicator check (KPI check) mechanism. The KPI check mainly relies on the parameters fed back by the circuit components of the communication system to perform comprehensive assessment. The frequency-division duplexing training process is started if any of the conditions are met; otherwise, the frequency-division duplexing training process is stopped if none of the conditions are met.

One of the technical concepts of the frequency-division duplexing training process is to obtain a best parameter setting through the self-adaptation method according to the critical reference indicators fed back by the communication system. The frequency-division duplexing training process can be applied to the communication having the at least two communication modules that may interference with each other when operating under the at least two communication protocols, so that the signal interference can be minimized. The performance of the coexisted communication modules of the communication system can be optimized.

Taking the system framework of the communication system shown in FIG. 2 as an example, in the beginning when the self-adaptation method is in operation, the processor 201 of the communication system relies on operating parameters of the at least two communication modules (e.g., the first communication module 207 and the second communication module 208 of FIG. 2) controlled by the controller 205 to determine whether the at least two communication modules operating under the at least two communication protocols operate with their individual antennas (step S401). If the at least two communication modules do not operate with their own individual antennas, the frequency-division duplexing training process is stopped (step S403).

If it is confirmed that the at least two communication modules operating under different communication protocols do operate with their own individual antennas, the following steps of the frequency-division duplexing training process are performed for introducing one or more reference indicators in step S405, S407, S409 and S411 to be indicators for determining whether or not the frequency-division duplexing training process continues. A first reference indicator is to determine whether the second communication module (e.g., the wireless network module) is operated in an access point (AP) that is operating in a specific frequency band (e.g., 2.4 GHz) (step S405). If the second communication module does not connect with the access point that is operating in the specific frequency band set by the communication system (represented as “no”), the frequency-division duplexing training process is stopped (step S403). On the contrary, when the second communication module 208 connecting with the access point operating in the specific frequency band is confirmed (represented as “yes”), a next assessment is performed.

Next, a second reference indicator is to measure an antenna isolation of each of different communication modules of communication systems manufactured by different manufacturers and determine whether the antenna isolation meets an isolation threshold that is set by the communication system according to the antenna isolation (step S407). It is determined whether or not the frequency-division duplexing training process is performed based on whether the antenna isolation meets the isolation threshold.

According to one embodiment of the present disclosure, the antenna isolation is configured to be a physical quantity used to evaluate a degree of mutual coupling between different antennas. One of the methods for measuring the antenna isolation is to make two communication modules of two antennas to respectively connect with two ports of a network analyzer. The network analyzer then generates test signals and inputs the test signals to a first communication module of a first antenna. The first antenna serves as a transmitter that broadcasts the test signals. A second antenna that serves as a receiver receives the test signals. The network analyzer determines whether the test signals can be identified according to the received signals, e.g., power. If the test signals fail to be identified, the test signals are required to be updated. The first antenna is again configured to broadcast updated test signals, and a second antenna receives the updated test signals. The network analyzer then determines whether or not the updated test signals can be identified from the received signals. The above steps are repeated until the test signals are successfully identified from the received signals, and the antenna isolation between two antennas can be obtained.

For example, in a condition of assessing whether or not to start the frequency-division duplexing training process, another condition may be assessed, e.g., if antenna isolation (Ant_iso) meets an isolation threshold (e.g., larger than 10 dB and smaller than 40 dB) set by the system (i.e., 10 dB<Ant_iso(dB)<40 dB); otherwise, the frequency-division duplexing training process is stopped (step S403). If the antenna isolation meets the isolation threshold (represented as yes), whether or not the at least two communication modules are in a non-idle state is determined (step S409).

In a third reference indicator described in step S409, if the self-adaptation method operated in the communication system determines that any or the at least two communication modules is under an idle state according to the signals generated by the controller (represented as “no”), the frequency-division duplexing training process is stopped (step S403). If the at least two communication modules are determined to be under a non-idle state according to the signals generated by the controller (represented as “yes”), it shows that the at least two communication modules are in operation, and the frequency-division duplexing training process is performed, or a next assessment is performed.

Next, referring to a system framework shown in FIG. 2, whether the frequency-division duplexing training process is performed is determined (step S411) according to whether a stereo audio transmission profile (e.g., Advanced Audio Distribution Profile, A2DP) that regulates a first communication module (e.g., the Bluetooth™ communication module) of the at least two communication modules to transmit or receive audio (e.g., a high-quality audio) is stored in the memory 203 of the communication system 20. For example, the stereo audio transmission profile can be a Bluetooth™ stereo audio transmission profile. In a fourth reference indicator, when the memory of the communication system does not store any stereo audio transmission profile (represented as “no”), the frequency-division duplexing training process is started (step S403). If the memory storing the stereo audio transmission profile is determined (represented as “yes”), it is determined that the frequency-division duplexing training process can be performed (step S413).

Referring to FIG. 4, the communication system determines whether or not the frequency-division duplexing training process is performed based on any, part of, or all of the multiple reference indicators. The frequency-division duplexing training process is configured to be performed when it is confirmed that the two communication modules (e.g., the Bluetooth™ communication module and the wireless network module) of the communication system operate with their independent antennas, the second communication module (e.g., the wireless network module) connects with an access point that operates in 2.4GHz frequency band, isolation between two antennas of the two different communication modules meets a threshold set by the communication system, both the two communication modules are under the non-idle state, and the memory of the communication system store a Bluetooth™ stereo audio transmission profile (A2DP).

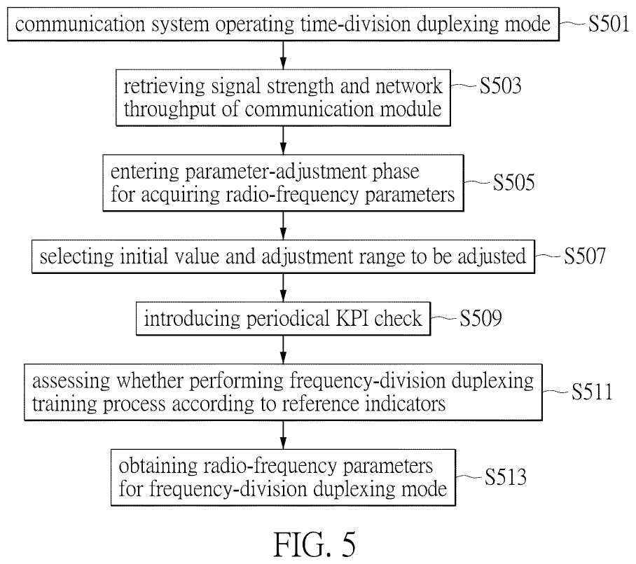

Based on the reference indicators described in FIG. 4 that are referred to for determining whether or not to perform the frequency-division duplexing training process, reference is made to FIG. 5, which is a flowchart illustrating a self-adaptation training process in the self-adaptation method for optimizing multiple communication modules coexisting in frequency-division duplexing according to one embodiment of the present disclosure.

In the beginning, the communication system is firstly operated under a time-division duplexing (TDD) model (step S501). The communication system includes at least two communication modules that can be the first communication module (e.g., the Bluetooth™ communication module) and the second communication module (e.g., the wireless network module).

Under a time-division duplexing mode, a software process performed in the communication system is configured to retrieve communication data generated by the first communication module and the second communication module. The communication data is such as a signal strength (RSSI) and a network throughput of the second communication module (step S503). One of the technical concepts is that a degree of the signal interferences generated by the at least two communication modules of the communication system that operates under different communication protocols is lowest, and therefore the performance of the coexisting wireless network and the Bluetooth™ communication modules can stably output data. The communication system can rely on the communication data (e.g., the wireless network throughput) of the at least two communication modules obtained in the beginning to establish a standard comparison value for a frequency-division duplexing mode in a next phase.

Next, the communication system enters a parameter-adjustment phase and receives multiple radio-frequency parameters of the at least two communication modules (step S505). The radio-frequency parameters are required to be adjusted. With a Bluetooth™ communication module and a wireless network module as an example, the radio-frequency parameters include a WiFi™ TX power level (dBm) of the wireless network module, a Bluetooth™ Degrade TX power level of the Bluetooth™ communication module and a Bluetooth™ RX LNA (low-noise amplifier) gain.

It should be noted that initial values and adjustment ranges of the above-mentioned three types of radio-frequency parameters to be adjusted are selected according to signal strengths of the signals generated by different communication modules (e.g., the Bluetooth™ communication module and the wireless network module) (step S507). Referring to a WiFi™ and Bluetooth™ signal strength relationship table 60, the KPI check is periodically performed based on the standard comparison value (step S509). One or more reference indicators are referred to for assessing whether or not to perform the frequency-division duplexing training process. When one or more reference indicators are matched, it is determined that the frequency-division duplexing training process is started or stopped (step S511). Accordingly, a set of radio-frequency parameters for the at least two communication modules (e.g., the Bluetooth™ communication module and the wireless network module) most suitable for the communication system which operates under the frequency-division duplexing mode can be obtained (step S513).

Thus, the radio-frequency parameters that are obtained by the above process allow the communication system to operate with a better coexisting performance of the network throughput than the coexisting performance under the time-division duplexing mode. The coexisting performance of the communication system operating with the radio-frequency parameters can be comparable with the throughput of a single wireless network device, and will not reduce the performance of the coexisting Bluetooth™ communication module.

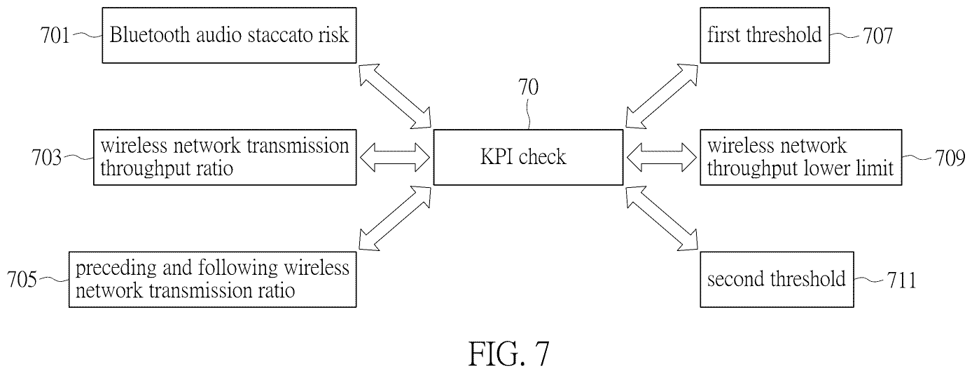

When the self-adaptation method for optimizing multiple communication modules coexisting in frequency-division duplexing of the present disclosure is in operation, one or more reference indicators in KPI check (e.g., steps S405, S407, S409 and S411 of FIG. 4) are applied to evaluate whether or not the frequency-division duplexing training process is performed. Reference is made to FIG. 7, which is a schematic diagram describing various reference indicators in a KPI check 70 applied to the self-adaptation method for optimizing multiple communication modules coexisting in frequency-division duplexing for comprehensively assessing whether or not the frequency-division duplexing training process is performed. For making the communication system having the multiple coexisting communication modules operate more stably, the self-adaptation method performs the KPI check 70 and also provides a mechanism of remedy and trading curb. The radio-frequency parameters applied to the communication system will be adjusted or recovered to an original setting once any feedback indicator is found to be abnormal for ensuring that the KPI check 70 will not affect stable operations of the communication system.

One of the indicators of KPI check 70 is a Bluetooth™ audio staccato risk 701. Whether there is a risk of staccato occurring is determined by checking whether audio packets transmitted by the Bluetooth™ communication module are normally inputted and outputted in a queue formed by a memory of the communication system. If the data in the queue is not normally consumed, it indicates that data is not smoothly transmitted and the firmware of the wireless network module cannot receive any consumption signal (e.g., an empty notification) from the firmware of the Bluetooth™ communication module. Accordingly, a related data such as a specific flag “no_empty_counter” will be gradually accumulated and reaches a threshold set by the system. In the meantime, the Bluetooth™ audio may suffer the staccato risk, and the KPI check 70 will confirm that the frequency-division duplexing training process should be performed for remedy.

Another indicator of the KPI check 70 is a wireless network transmission throughput ratio 703. According to one embodiment of the present disclosure, the wireless network transmission throughput ratio 703 can be a ratio between a first throughput (Mbps) of the wireless network module under a frequency-division duplexing mode (FDD mode) and a second throughput of the wireless network module under a time-division duplexing mode (TDD mode). When the communication system enters the frequency-division duplexing mode, the wireless network transmission throughput ratio 703 is calculated at every time the radio-frequency parameters are adjusted for determining whether the throughput ratio of the wireless network module meets a standard. The frequency-divisional duplexing training process is determined to be performed for remedy if the throughput ratio is lower than the standard.

One more indicator of the KPI check 70 is a preceding and following wireless network transmission ratio 705. According to one embodiment of the present disclosure, the preceding and following wireless network transmission ratio 705 is obtained by calculating a ratio between a latest throughput (Mbps) of the wireless network module and a previous throughput of the wireless network module under the frequency-division duplexing mode. The communication system checks whether the throughput of the wireless network module meets a standard by comparing the preceding and following wireless network transmission ratio 705 with a standard set by the system. If the preceding and following wireless network transmission ratio 705 is lower than the standard, the frequency-division duplexing training process is required to be performed for remedy.

One further indicator of the KPI check 70 is strength of noises observed at a baseband of the communication module. If the noises generated by the communication module due to external influences exceed a first threshold 707 set by the system, a trading curb is determined to be performed for the communication system to be recovered from an original setting.

One more indicator of the KPI check 70 is a lower limit 709 of the throughput of wireless network. When the communication system enters the frequency-division duplexing mode, for every time the radio-frequency parameters are adjusted, the throughput of the wireless network module will be checked to determine whether it is lower than the lower limit 709. If the throughput is lower than the lower limit 709, it shows that the operation of the whole communication system is affected, and the communication system will perform a trading curb that allows the communication system to be recovered to an original setting.

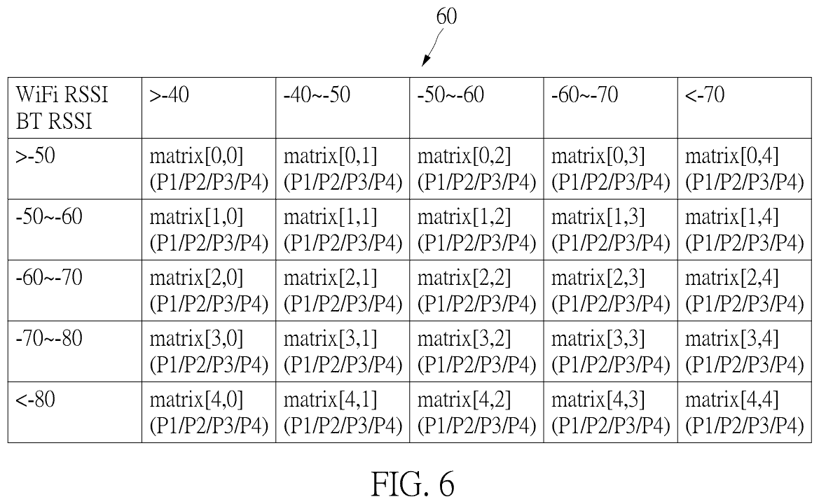

A second threshold 711 is set for a related indicator. For example, in the process of adjusting operating parameters of the communication modules, the signal strengths (RSSI) of the wireless network module and the Bluetooth™ communication module are firstly checked to determine whether there is any change. If the signal strengths are changed, it is determined whether a quantity of changes exceeds the second threshold 711. If the quantity of the changes of the signal strengths exceeds the second threshold 711, the operating parameters are required to be adjusted again. For example, the operating parameter can be adjusted within a range defined by a WiFi™ and Bluetooth™ signal strength relationship table 60 exemplarily shown in FIG. 6.

According to an exemplary example of the WiFi™ and Bluetooth™ signal strength relationship table 60, a horizontal column denotes ranges of WiFi™ signal strengths and Bluetooth™ signal strengths, and a vertical column denotes ranges of Bluetooth™ signal strengths. The ranges in the horizontal column exemplarily include “>−40”, “−40˜−50”, “−50˜−60”, “−60˜−70” and “<−70.” The ranges in the vertical column exemplarily include “>−50”, “−50˜−60”, “−60˜−70”, “−70˜−80” and “<−80.” The array fields including matrix[0,0], matrix[0,1], . . . , matrix[4,4] denote that the signal strengths of the two communication modules correspond to the ranges of fine-tuned radio-frequency parameters. The parameter “P1” indicates a minimum WiFi™ TX power level, “P2” indicates a maximum WiFi™ TX power level, “P3” indicates a maximum BT degrade TX power index and a BT RX LNA (low-noise amplifier) gain index.

For example, when a wireless network signal strength is “−45 dBm” and a Bluetooth™ communication signal strength is “−55 dBm”, adjustment parameters are found to be “P1=5, P2=15, P3=25 and P4=5” in matrix[1,1] by querying the WiFi™ and Bluetooth™ signal strength relationship table 60. Accordingly, an initial value of the transmission power for the wireless network module can be fine-tuned as “(P1+P2)/2=(5+15)/2=10 dBm”, and the transmission power of the Bluetooth™ communication module can be reduced to “P3/2=25/2=12, 12*0.5=6 dB.” In one further example, if an original transmission power of the Bluetooth™ communication module is “4 dBm”, the transmission power of the Bluetooth™ communication module can be reduced by “6 dB” in the beginning under the frequency-division duplexing mode, and the transmission power of the Bluetooth™ communication module will be “4−6=−2 dBm.” Further, a level of a Bluetooth™ RX low-noise amplifier gain can be “P4=5.” When different frequency-division duplexing phases are switched, the level of the transmission power of the wireless network module will be changed and a value indexing the transmission power of the Bluetooth™ communication module will be downgraded for obtaining a best set of radio-frequency parameters suitable for the two communication modules.

Applications are provided as follows when applying the self-adaptation method for optimizing multiple communication modules coexisting in frequency-division duplexing.

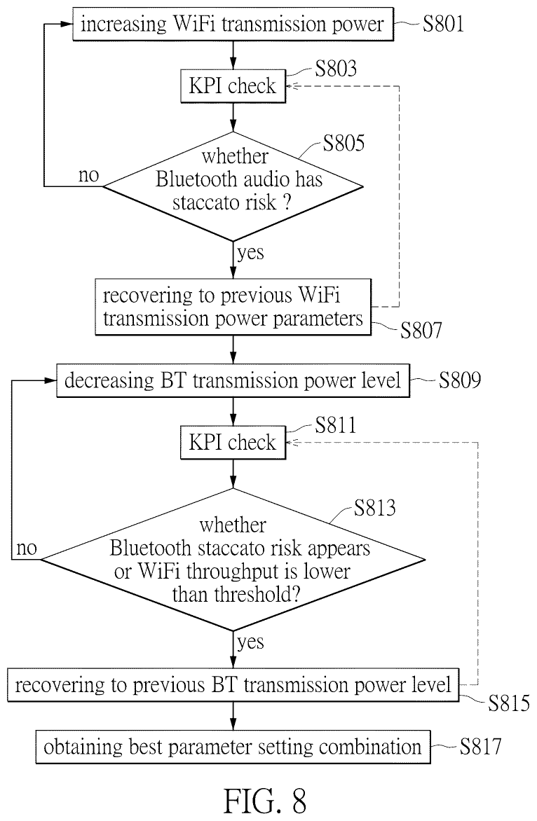

Case 1: coexisting wireless network uplink (station mode) and Bluetooth™ communication audio transmission mode:
Reference is made to FIG. 8, which is a flowchart illustrating the self-adaptation method for optimizing multiple communication modules coexisting in frequency-division duplexing according to one embodiment of the present disclosure. In the flowchart, “WiFi” denotes the wireless network module and “BT” denotes the Bluetooth™ communication module.

Upon consideration of both the wireless network module and the Bluetooth™ communication module operating in the same frequency band, the Bluetooth™ communication module that transmits data will be interfered when the wireless network module transmits data at the same time. FIG. 8 shows an operating logic of the frequency-division duplexing training process. In the beginning, the transmission power of the wireless network module (WiFi™ TX Power) is increased (step S801). For example, the transmission power is increased by 1 dB each time, and KPI check is performed anytime (step S803) for determining whether the Bluetooth™ audio suffers staccato risk (step S805). If there is no staccato risk occurring to the Bluetooth™ communication module after the transmission power of the wireless network module is increased (represented as “no”), the process goes back to step S801. On the contrary, if it is determined that the Bluetooth™ audio may suffer staccato risk (represented as “yes”), the parameters such as the transmission power of the wireless network module are recovered to the parameters prior to when the staccato risk is found (step S807). In the meantime, the above steps S803 and S805 are repeated and KPI check is performed (step S803) for determining whether the Bluetooth™ audio will suffer staccato risk (step S805). The subsequent steps can be performed when no staccato risk is confirmed.

Next, the transmission power level of the Bluetooth™ communication module (BT TX power level) is gradually decreased (step S809), and KPI check is also performed (step S811). In the process of KPI check, it is determined that whether any staccato risk exists or the network throughput of the wireless network is lower than a threshold (step S813). If no staccato risk exists or the network throughput is not lower than the threshold set by the communication system (represented as “no”), the process goes back to step S809 for again decreasing the transmission power level of the Bluetooth™ communication module. If staccato risk exists on the Bluetooth™ audio or the network throughput of wireless network is lower than the threshold (represented as “yes”) after the transmission power of the Bluetooth™ communication module is adjusted, the parameters are recovered to the previous parameters (i.e., the previous transmission power level of the Bluetooth™ communication module when the network throughput is lower than the threshold (step S815). In the meantime, the above steps S811 and S813 are repeated and KPI check is performed again (step S811) for determining whether staccato risk exists on the Bluetooth™ audio or the network throughput of the wireless network module is lower than the threshold (step S813). When it is confirmed that no staccato risk exists and the network throughput is not lower than the threshold, a best set of combined parameters are obtained (step S817). The combined parameters are a combination of the transmission power of the wireless network module and the transmission power of the Bluetooth™ communication module. Accordingly, the coexisting performance of the communication module can be optimized.

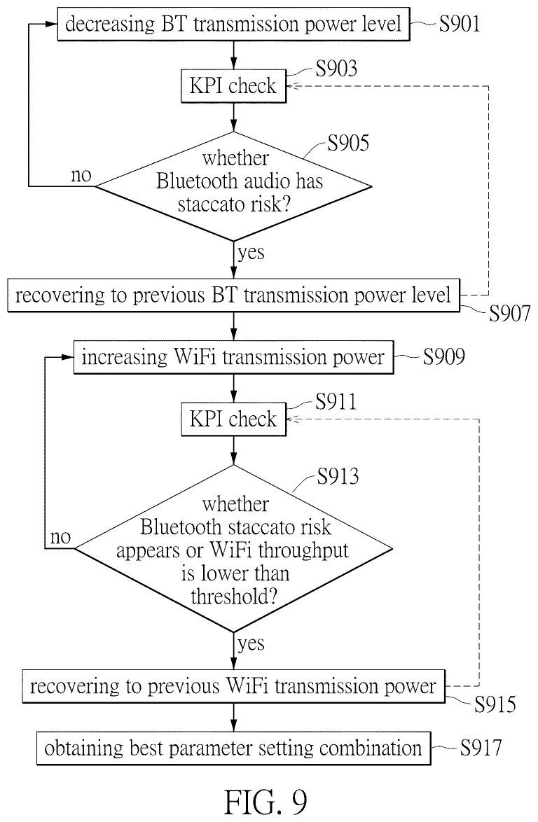

Case 2: coexisting wireless network downlink (station mode) and Bluetooth™ communication audio transmission mode:
Reference is made to FIG. 9, which is another flowchart illustrating the self-adaptation method for optimizing multiple communication modules coexisting in frequency-division duplexing according to another embodiment of the present disclosure.

Upon consideration of both the wireless network module and the Bluetooth™ communication module operating in the same frequency band and the wireless network module being interfered when the Bluetooth™ communication module is transmitting data, an operating logic of the frequency-division duplexing training process can be referred to in FIG. 9. In the beginning, a transmission power level (BT TX power level) of the Bluetooth™ communication module is gradually decreased (step S901), and the interference with the wireless network module as receiving data can be reduced. However, the staccato risk may occur to Bluetooth™ audio when the transmission power of the Bluetooth™ communication module is decreased, and the KPI check is required to be performed at anytime.

In the KPI check process (step S903) that is used to determine whether there is any staccato risk existing on the Bluetooth™ audio (step S905), if no staccato risk exists on the Bluetooth™ audio (represented as “no”), the process goes back to step S901 for again decreasing the transmission power level of the Bluetooth™ communication module. If the staccato risk already exists on the Bluetooth™ audio (represented as “yes”), the parameters (e.g., the transmission power level of the Bluetooth™ communication module) prior to when the staccato risk is found in the Bluetooth™ audio can be recovered (step S907).

In the meantime, the above steps S903 and S905 including the KPI check process can be repeated (step S903) so as to determine whether any staccato risk exists on Bluetooth™ audio (step S905). When no staccato risk is determined, the transmission power of the wireless network module (WiFi™ TX power) can be increased (step S909) by 1 dB each time, and the KPI check is also performed (step S911) for determining whether the staccato risk exists or the network throughput is lower a threshold (step S913). If no staccato risk exists on the Bluetooth™ audio or the network throughput of the wireless network is not lower than the threshold set by the communication system when the KPI check is performed (represented as “no”), the process goes back to step S909 that the transmission power of the wireless network module is again increased and the KPI check continues. On the contrary, if there is no staccato risk existing on the Bluetooth™ audio or the network throughput of the wireless network is lower than the threshold set by the communication system (represented as “yes”), the parameters (i.e., the transmission power of the wireless network module) prior to when the staccato risk occurs to the Bluetooth™ audio or the network throughput of the wireless network is lower than the threshold are recovered (step S915). In the meantime, the above steps S911 to S913 are repeated, and KPI check is again performed (step S911) for determining whether the staccato risk exists on the Bluetooth™ audio or the network throughput of the wireless network is lower than the threshold (step S913). The subsequent steps go on when no staccato risk or the network throughput not lower than the threshold is confirmed.

Thus, a best set of combined parameters of the transmission powers of the wireless network module and the Bluetooth™ communication modules can be obtained through the above process (step S917), and performance of the coexisting wireless network module and the Bluetooth™ communication module can be optimized.

In conclusion, according to the above embodiments relating to the self-adaptation method for optimizing multiple communication modules coexisting in frequency-division duplexing and the communication system of the present disclosure, the feedback parameters of the communication system and the coexisting performance being monitored in real time are referred to for automatically adjusting the radio-frequency parameters so as to obtain optimized combined parameters of the transmission powers of the wireless network module and the Bluetooth™ communication module. Therefore, the signal-to-noise ratio of the communication system can be optimized and the risk of signal interferences among the multiple communication modules can be reduced. When the self-adaptation method for optimizing multiple communication modules coexisting in frequency-division duplexing is applied to system factories, even if various communication products are required to be assessed, the self-adaptation method allows the system factories to automatically obtain a best set of radio-frequency parameters by self-adapting to the current environment.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A self-adaptation method for optimizing multiple communication modules coexisting in frequency-division duplexing, which is operated in a communication system having at least two communication modules under different communication protocols, comprising:
operating the communication system under a time-division duplexing mode, receiving communication data generated by the at least two communication modules and generating standard comparison values of the communication system under a frequency-division duplexing mode;
entering the communication system into a parameter-adjustment phase and obtaining radio-frequency parameters of the at least two communication modules;
periodically performing a key performance indicator check according to the standard comparison values, and assessing executing or stopping a frequency-division duplexing training process according to one or more reference indicators, so as to determine whether the radio-frequency parameters of the at least two communication modules are required to be adjusted; and
obtaining a set of radio-frequency parameters applicable to the communication system which is operated under the frequency-division duplexing mode.

2. The self-adaptation method according to claim 1, wherein, in the key performance indicator check, a processor of the communication system determines whether the at least two communication modules operating under different communication protocols operate with individual antennas to determine whether or not to perform the frequency-division duplexing training process.

3. The self-adaptation method according to claim 2, wherein the frequency-division duplexing training process is stopped when the at least two communication modules operating under different communication protocols do not operate with individual antennas.

4. The self-adaptation method according to claim 2, wherein, when the at least two communication modules operating individual antennas is confirmed, whether or not a second communication module connects with an access point that operates in a frequency band is confirmed; wherein, when the second communication module does not connect with the access point, the frequency-division duplexing training process is stopped.

5. The self-adaptation method according to claim 1, wherein, in the key performance indicator check, antenna isolation between the at least two communication modules of the communication system is measured, whether or not the frequency-division duplexing training process is performed based on whether the antenna isolation meets an isolation threshold set by the communication system is determined.

6. The self-adaptation method according to claim 5, wherein, when the antenna isolation of the at least two communication modules meets the isolation threshold, whether the at least two communication modules operating in a non-idle state is determined.

7. The self-adaptation method according to claim 6, wherein, when all or any of the at least two communication modules are in an idle state, the frequency-division duplexing training process is stopped.

8. The self-adaptation method according to claim 6, wherein, when the at least two communication modules are in a non-idle state, the frequency-division duplexing training process is performed, or another condition is assessed.

9. The self-adaptation method according to claim 1, wherein, in the key performance indicator check, whether the frequency-division duplexing training process is performed is determined according to whether a stereo audio transmission profile that regulates a first communication module of the at least two communication modules to transmit or receive audio is stored in a memory of the communication system.

10. The self-adaptation method according to claim 9, wherein, when the memory does not store the stereo audio transmission profile, the frequency-division duplexing training process is stopped; and, when the memory stores the stereo audio transmission profile, the frequency-division duplexing training process is performed.

11. The self-adaptation method according to claim 1, wherein the at least two communication modules include a Bluetooth™ communication module and a wireless network module; wherein the communication data used as the standard comparison values includes signal strengths of signals of the Bluetooth™ communication module and the wireless network module when the communication system operates under the time-division duplexing mode, and network throughput of the wireless network module.

12. The self-adaptation method according to claim 11, wherein the radio-frequency parameters of the at least two communication modules include a transmission power level of the wireless network module, a transmission power level of the Bluetooth™ communication module and a Bluetooth™ RX low-noise amplifier gain.

13. The self-adaptation method according to claim 12, wherein initial values and adjustment ranges of the radio-frequency parameters to be adjusted are selected according to signal strengths of signals generated by the at least two communication modules.

14. The self-adaptation method according to claim 11, wherein, in the key performance indicator check, whether there is a staccato risk is determined by checking whether audio packets transmitted by the Bluetooth™ communication module are normally inputted and outputted in a queue formed by a memory of the communication system.

15. The self-adaptation method according to claim 11, wherein, in the key performance indicator check, whether a throughput of the wireless network module meets a standard is determined by checking a ratio between a first throughput of the wireless network module under the frequency-division duplexing mode and a second throughput of the wireless network module under the time-division duplexing mode.

16. The self-adaptation method according to claim 11, wherein, in the key performance indicator check, whether a throughput of the wireless network module meets a standard is determined by calculating a ratio between a latest throughput and a previous throughput of the wireless network module under the frequency-division duplexing mode.

17. The self-adaptation method according to claim 11, wherein, in the key performance indicator check, whether a trading curb is performed for stopping the communication system is determined by determining whether noises generated by operation of a baseband of any of the communication modules exceed a threshold of baseband signals.

18. The self-adaptation method according to claim 11, wherein, in the key performance indicator check, when the communication system enters the frequency-division duplexing mode, whether a trading curb is performed is determined by checking whether a throughput of the wireless network module is lower than a lower limit of the throughput based on the radio-frequency parameters being adjusted at every time.

19. The self-adaptation method according to claim 11, wherein, in the key performance indicator check, whether signal strengths of the wireless network module and the Bluetooth™ communication module are changed is determined; and the radio-frequency parameters are required to be adjusted when the signal strengths are changed and a number of changes exceeds a threshold.

20. A communication system, comprising:
at least two communication modules which are operated under different communication protocols; and
a processor, controlling, via a controller, operations of the at least two coexisting communication modules, and performing a self-adaptation method for optimizing multiple communication modules coexisting in frequency-division duplexing, comprising:
operating the communication system under a time-division duplexing mode, receiving communication data generated by the at least two communication modules and generating standard comparison values of the communication system under a frequency-division duplexing mode;
entering the communication system a parameter-adjustment phase and obtaining radio-frequency parameters of the at least two communication modules;
periodically performing a key performance indicator check according to the standard comparison values, and assessing executing or stopping a frequency-division duplexing training process according to one or more reference indicators so as to determine whether the radio-frequency parameters of the at least two communication modules are required to be adjusted; and
obtaining a set of radio-frequency parameters applicable to the communication system which is operated under the frequency-division duplexing mode.
